(19) United States
(12) Patent Application Publication
(10) Pub. No.: US 2025/0360815 A1
(43) Pub. Date: Nov. 27, 2025

(54) DEVICE FOR INDUCTIVE CHARGING

(71) Applicant: Siemens Aktiengesellschaft, München (DE)

(72) Inventors: Martin Pavlovsky, München (DE); Denis Kraus, München (DE); Young Hun Lee, Baldham (DE)

(21) Appl. No.: 19/215,647

(22) Filed: May 22, 2025

(30) Foreign Application Priority Data
May 22, 2024 (DE) 10 2024 204 711.2

(51) Int. Cl. B60L 53/122; B60L 53/62; H02J 50/12

(52) U.S. Cl. CPC B60L 53/122; B60L 53/62; H02J 50/12

(57) ABSTRACT

A device inductively charges an electrical energy storage apparatus, in particular a battery of an electric vehicle. The device contains a wallbox circuit having an inverter and an output, a ground circuit having an input and a charging coil, a cable that provides an electrical connection between the output of the wallbox circuit and the input of the ground circuit, and a controllable capacitor circuit, The controllable capacitor circuit is configured to set a series capacitance at the output of the wallbox circuit or at the input of the ground circuit, in order to achieve impedance matching to a receiver circuit connected to the electrical energy storage apparatus.

### CROSS-REFERENCE TO RELATED APPLICATION

This application claims the priority, under 35 U.S.C. § 119, of German Patent Application DE 10 2024 204 711.2, filed May 22, 2024; the prior application is herewith incorporated by reference in its entirety.

### FIELD AND BACKGROUND OF THE INVENTION

The present invention relates to the field of inductive charging of electrical energy storage devices, in particular devices for inductively charging an electrical energy storage device, for example, a battery of an electric vehicle, to uses of such devices, and to a method.

### TECHNICAL BACKGROUND

Known devices for inductively charging batteries, for example, in electric vehicles, typically consist of two circuits, a wallbox circuit and a ground circuit (ground assembly), which are connected using a cable. Efficient energy transmission from the charging coil in the ground circuit to the receiver coil in a vehicle standing above the ground circuit requires impedance matching between the charging device and the receiver circuit having the receiver coil. In particular for interoperable charging devices, which can charge multiple different vehicle types using correspondingly different receiver circuits, this impedance matching can be carried out by multiple impedance changes both in the charging device and in the receiver circuit, which is connected to great effort and high costs.

### SUMMARY OF THE INVENTION

The present invention is based on the object of enabling simplified impedance matching between charging device and receiver circuit.

A device, its use, and a method are described below.

According to a first aspect of the invention, a device is described for inductively charging an electrical energy storage device, in particular a battery of an electric vehicle. The device includes (a) a wallbox circuit having an inverter and an output, (b) a ground circuit having an input and a charging coil, (c) a cable that provides an electrical connection between the output of the wallbox circuit and the input of the ground circuit, and (d) a controllable capacitor circuit, which is configured to set a series capacitance at the output of the wallbox circuit or at the input of the ground circuit in order to achieve impedance matching to a receiver circuit connected to the electrical energy storage device.

The described device is based on the finding that by setting a series capacitance at the output of the wallbox circuit or at the input of the ground circuit, a simple possibility can be provided for the impedance matching, which in particular does not require additional impedance changes at other points in the charging device and/or receiver circuit.

According to one exemplary embodiment, the controllable capacitor circuit is configured to set the series capacitance at the output of the wallbox circuit or at the input of the ground circuit by switching on or off at least one series capacitor.

In other words, the controllable capacitor circuit can switch on or introduce a series capacitor to increase the series capacitance at the output of the wallbox circuit or at the input of the ground circuit, or it can switch off or remove an existing or previously switched-on series capacitor to reduce the series capacitance at the output of the wallbox circuit or at the input of the ground circuit.

According to a further exemplary embodiment, the output and/or the input contains two conductors, wherein the switching on or off of at least one series capacitor takes place in one of the two conductors or in both conductors.

The effort linked to setting the series capacitance is less if the series capacitor is switched on or off in only one conductor. In contrast, the symmetry linked to switching on or off a series capacitor in both conductors can be advantageous.

According to a further exemplary embodiment, the controllable capacitor circuit is configured to switch between a plurality of statuses, wherein in each status, a respective series capacitance is set at the output of the wallbox circuit or at the input of the ground circuit.

In other words, it is possible to switch between various statuses, so that accordingly different series capacitances can be set. Impedance matching can thus be achieved in a simple manner by a matching selection of the various series capacitances.

According to a further exemplary embodiment, the plurality of statuses contains a status in which no series capacitor is switched on at the output of the wallbox circuit or at the input of the ground circuit.

In other words, no additional series capacitor is present in this status. This status can advantageously be used as the base status, in which impedance matching with a known receiver circuit is to be expected under typical conditions, in particular with regard to the positioning of the vehicle, without readjustment. If good coupling between charging device and receiving circuit should nonetheless not be provided, it is possible to change to another status.

According to a further exemplary embodiment, the plurality of statuses comprises a first status, in which at least one first series capacitor is switched on at the output of the wallbox circuit or at the input of the ground circuit.

In the first status, the set series capacitance is therefore determined entirely or partially by the capacitance of the first series capacitor.

According to a further exemplary embodiment, the plurality of statuses contains a second status, in which at least one second series capacitor is switched on at the output of the wallbox circuit or at the input of the ground circuit.

In the second status, the set series capacitance is therefore entirely or partially determined by the capacitance of the second series capacitor.

According to a further exemplary embodiment, the first series capacitor and the second series capacitor have different capacitances.

In other words, different series capacitances can accordingly be set by changing between the first and second statuses.

A second aspect of the invention describes the use of a device according to the first aspect for charging an electrical energy storage device, in particular for charging a battery of an electric vehicle.

The described use is essentially based on the same finding as the above-described device according to the first aspect, namely that by setting a series capacitance at the output of the wallbox circuit or at the input of the ground circuit, particularly simple impedance matching is enabled.

A third aspect of the invention describes a method which comprises the following: (a) providing a wallbox circuit having an inverter and an output, (b) providing a ground circuit having an input and a charging coil, (c) providing a cable that provides an electrical connection between the output of the wallbox circuit and the input of the ground circuit, and (d) providing a controllable capacitor circuit, which is configured to set a series capacitance at the output of the wallbox circuit or at the input of the ground circuit in order to achieve impedance matching to a receiver circuit connected to the electrical energy storage device.

The method according to this third aspect is also essentially based on the same concept as the above-described device according to the first aspect and in particular consists of providing such a device.

It is to be noted that the series capacitance can be set either at the output of the wallbox circuit or at the input of the ground circuit using the present invention. The simplification of the impedance matching according to the invention can be achieved similarly using both variants (i.e. both using setting of the series capacitance at the output of the wallbox circuit and also using setting of the series capacitance at the input of the ground circuit), since both variants are electrically equivalent. The precise positioning of the series capacitors can therefore be freely selected on the basis of the overall circumstances in the implementation.

Other features which are considered as characteristic for the invention are set forth in the appended claims.

Although the invention is illustrated and described herein as embodied in a device for inductive charging, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a circuit diagram showing an exemplary inductive charging device;

FIGS. 2 to 4 are graphs showing an influence of various impedance changes in the charging device shown in FIG. 1 on the impedance level of the ground circuit;

FIG. 5 is a graph showing an array of operating points in the impedance level of the ground circuit;

FIG. 6 is a circuit diagram showing the inductive charging device according to one exemplary embodiment of the present invention;

FIG. 7 is a graph showing an impedance level of a ground circuit of the charging device shown in FIG. 6; and

FIG. 8 is a circuit diagram of a controllable capacitor circuit according to the exemplary embodiment shown in FIG. 6.

### DETAILED DESCRIPTION OF THE INVENTION

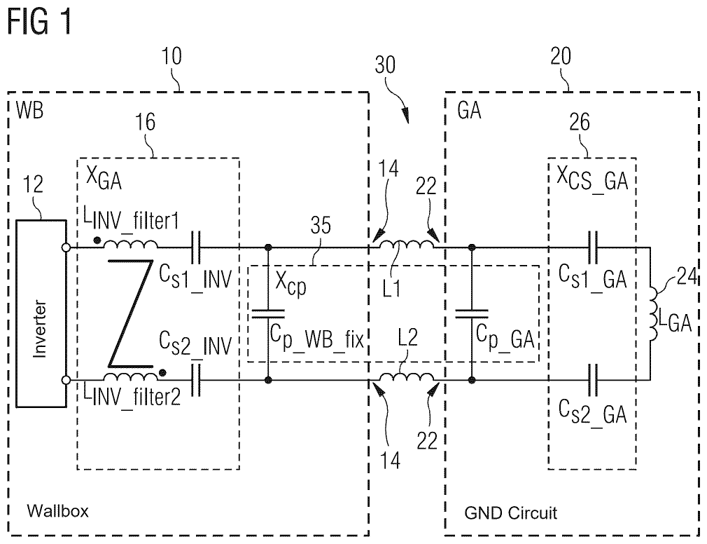

Referring now to the figures of the drawings in detail and first, particularly to FIG. 1 thereof, there is shown an exemplary inductive charging device, which is configured to inductively charge an electric vehicle via a charging coil installed in the ground, for example, below a parking space. The charging device contains a wallbox circuit 10, a ground circuit 20, and a cable 30. The wallbox circuit has an inverter 12, an output 14, and a filter circuit 16 (inductances L_{INV_filter1} and L_{INV_filter2} and capacitors C_{s1_INV} and C_{s2_INV}). The ground circuit 20 includes an input 22, a charging coil 24 having inductance LGA and a series capacitor circuit 26 (capacitors C_{s1_GA} and C_{s2_GA}). The cable 30 includes inductances L₁ and L₂ and provides an electrical connection between the output 14 of the wallbox circuit 10 and the input 22 of the ground circuit 20. Furthermore, for the purposes of the following discussion, FIG. 1 shows a parallel capacitor circuit 35 having a first parallel capacitor C_{p_WB_fix} at the output 14 of the wallbox circuit 10 and a second parallel capacitor C_{p_GA} at the input 22 of the ground circuit 20. It is to be noted here that the parallel capacitor circuit 35 shown in FIG. 1 is not known in the prior art and is shown and discussed here as one of multiple options for impedance matching. It should furthermore be noted that the device has still further components and features which are not relevant, however, in the present context and are not shown for the sake of simplification.

If an accordingly equipped vehicle, in particular an electric vehicle or a bus, truck, or the like, is positioned having a receiver coil above the ground coil 24, the battery of the vehicle can be charged by inductive coupling between the ground coil 24 and the receiver coil. For good inductive coupling, impedance matching of the charging device to the receiver circuit of the vehicle contains the receiver coil has to be provided.

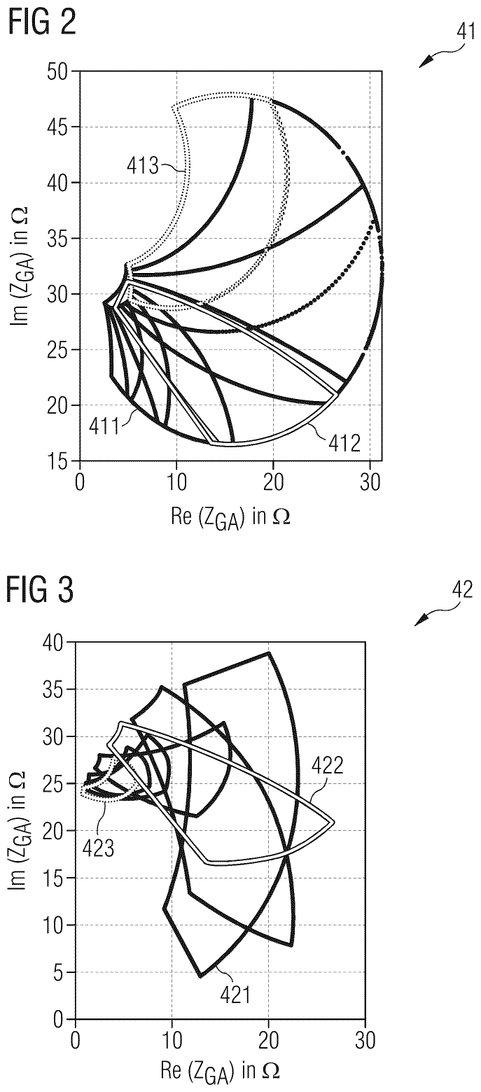

As explained hereinafter with reference to FIGS. 2 to 5, the required impedance matching cannot be achieved in a simple manner by changing the various impedances shown in FIG. 1, however.

FIG. 2 shows the influence of changes in the reactance X_{GA} of the filter circuit 16. In this case, each curve in the diagram 41 shows a corresponding impedance level in relation to the ground circuit 20 for various values of the reactance X_{GA}. The curve 411 corresponds to a lowest value, for example X_{GA_min}=1Ω, the curve 412 corresponds to a nominal value, for example, X_{GA_nom}=12.616Ω and the curve 413 corresponds to a highest value, for example, X_{GA_max}=25Ω. It can therefore be seen from FIG. 2 that with increasing reactance X_{GA}, the impedance level becomes greater and is pivoted upward.

FIG. 3 shows the influence of changes in the reactance X_{CP} of the parallel capacitor circuit 35 shown in FIG. 1. In this case, each curve in the diagram 42 shows a corresponding impedance level in relation to the ground circuit 20 for various values of the reactance X_{CP}. The curve 423 corresponds to a lowest value X_{CP_min} (corresponding, for example, to a maximum parallel capacitance C_{p_max}=289.74 nF), the curve 422 corresponds to a nominal value X_{CP_nom} (corresponding, for example, to a nominal parallel capacitance C_{p_nom}=131.7 nF), and the curve 421 corresponds to a highest value X_{CP_max} (corresponding, for example, to a minimum parallel capacitance C_{p_min}=52.86 nF). It can therefore be seen from FIG. 3 that with increasing reactance X_{CP} (i.e. with decreasing parallel capacitance Cₚ), the impedance level becomes greater, is rotated, and is shifted to the right.

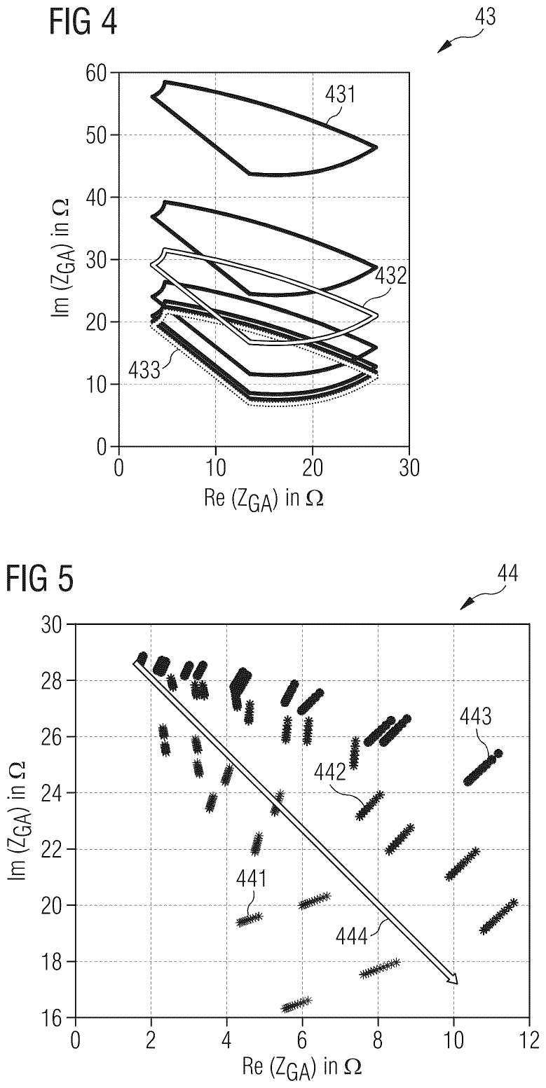

FIG. 4 shows the influence of changes in the reactance X_{Cs_GA} of the series capacitor circuit 26 shown in FIG. 1. In this case, each curve in the diagram 43 shows a corresponding impedance level with respect to the ground circuit 20 for various values of the reactance X_{Cs_GA}. The curve 433 corresponds to a lowest value X_{Cs_GA}_min (corresponding, for example, to a maximum series capacitance C_{s_max}=228.8 nF), the curve 432 corresponds to a nominal value X_{Cs_GA}_nom (corresponding, for example, to a nominal series capacitance C_{s_nom}=104 nF), and the curve 431 corresponds to a highest value X_{Cs_GA_max} (corresponding, for example, to a minimum series capacitance C_{s_min}=41.6 nF). It can therefore be seen from FIG. 4 that with increasing reactance X_{Cs_GA} (i.e. with decreasing series capacitance Cₛ) the impedance level maintains its size and shape, but is shifted upward.

FIG. 5 shows a diagram 44 having an array of operating points in the impedance level of the ground circuit for three different receiver circuits. In this case, the points 441 refer to a reference receiver circuit having a first impedance Z1, the points 442 refer to a reference receiver circuit having a second impedance Z2, and the points 443 refer to a reference receiver circuit having a third impedance Z3. In general, the operating points arranged at the top left in the diagram 44 correspond to a weaker coupling between ground circuit and receiver circuit, while the operating points arranged at the bottom right in the diagram 44 correspond to a stronger coupling. This relationship is indicated by the arrow 444.

It can therefore be seen looking back at the diagrams 41, 42, and 43 in FIGS. 2 to 4 that shifting the impedance level along the arrow 444 is only possible by complex matches of multiple impedances in the device shown in FIG. 1, so that the various shifts, rotations, and size changes shown in FIGS. 2 to 4 can result in combination in the desired shift.

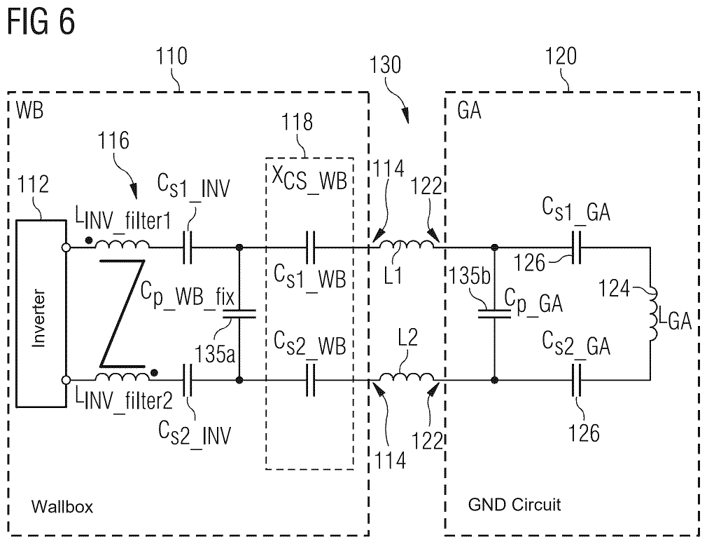

This complexity is avoided using the inductive charging device according to the invention shown in FIG. 6. Specifically, FIG. 6 shows an inductive charging device according to the invention which is identical to the device shown in FIG. 1 except for a decisive difference.

FIG. 6 shows an inductive charging device according to the invention which is configured to inductively charge an electric vehicle via a charging coil installed in the ground, for example, below a parking space. The charging device according to the invention comprises a wallbox circuit 110, a ground circuit 120, and a cable 130. The wallbox circuit comprises an inverter 112, an output 114, and a filter circuit 116 (inductances L_{INV_filter1} and L_{INV_filter2} and capacitors C_{s1_INV} and C_{s2_INV}). The ground circuit 120 comprises an input 122, a charging coil 124 having inductance LGA and a series capacitor circuit 126 (capacitors C_{s1_GA} and C_{s2_GA}). The cable 130 comprises inductances L₁ and L₂ and provides an electrical connection between the output 114 of the wallbox circuit 110 and the input 122 of the ground circuit 120. Furthermore, FIG. 6 also shows a parallel capacitor circuit having a first parallel capacitor 135a or C_{p_WB_fix} at the output 114 of the wallbox circuit 110 and a second parallel capacitor 135b or C_{p_GA} at the input 122 of the ground circuit 120. It is to be noted that the parallel capacitor circuit shown in FIG. 6 is not essential for the present invention and was only shown and discussed here as one of multiple options for impedance matching. It should also be noted here that the device may comprise still further components and features which are not relevant, however, in the present context and are not shown for the sake of simplification.

In contrast to the device of FIG. 1, the device according to the invention contains a controllable capacitor circuit 118. In the example shown, the controllable capacitor circuit 118 contains two series capacitors C_{s1_WB} and C_{s2_WB}. As described hereinafter, the capacitances of these series capacitors can be changed to achieve the required impedance matching by setting the series capacitance at the output 114 of the wallbox circuit 110 in a simple manner. It is to be noted that the same advantageous effect can be achieved if the controllable capacitor circuit 118 is attached at the input 122 of the ground circuit 122 instead of at the output 114 of the wallbox circuit 110. However, only the variant shown in FIG. 6 is explained in detail hereinafter for the purpose of simplification. Exemplary embodiments according to the invention, in which the controllable capacitor circuit is attached at the input 122 of the ground circuit 120, i.e. at the other end of the cable 130, are therefore not shown but are similarly included by the appended claims.

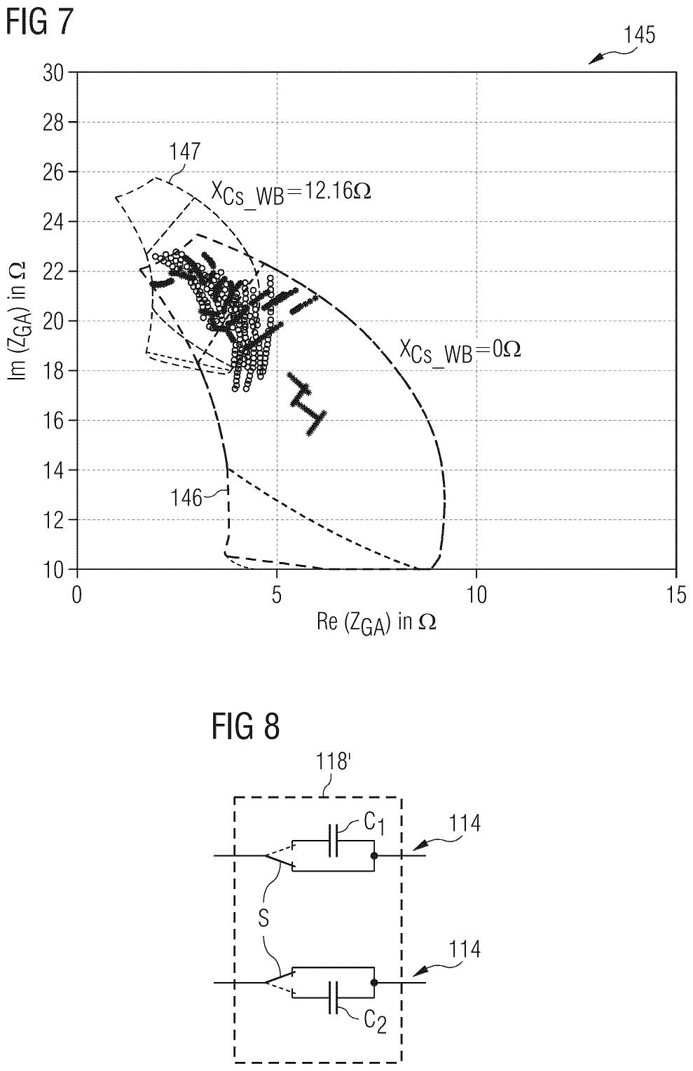

If an accordingly equipped vehicle, in particular an electric vehicle or a bus, truck, or the like, is positioned with a receiver coil above the ground coil 124, the battery of the vehicle can be charged by inductive coupling between the ground coil 124 and the receiver coil. The impedance matching of the charging device required for good inductive coupling can be achieved at the receiver circuit comprising the receiver coil in a simple manner using the present invention. This can be seen in particular from the illustration in FIG. 7.

FIG. 7 shows, with diagram 145, the influence of changes in the series capacitance Cs set at the output 114 of the wallbox circuit 110 on the impedance level of the ground circuit of the charging device according to the present invention shown in FIG. 6. Each curve in the diagram 145 shows, for various values of the series capacitance Cs or the corresponding reactance X_{Cs_WB}, a corresponding impedance level in relation to the ground circuit 120. The curve 145 corresponds here to a minimum reactance X_{Cs_WB}=0Ω and the curve 147 corresponds to a maximum reactance X_{Cs_WB}=12.16Ω. With increasing reactance X_{Cs_WB} (i.e. with decreasing series capacitance Cₛ), the impedance level only rotates slightly, becomes somewhat smaller, and moves to the left and upward in the diagonal direction. It can be clearly seen that this change precisely corresponds to the behavior of the operating points with decreasing coupling (cf. FIG. 5). A large number of operating points can thus be covered using the two settings X_{Cs_WB}=0Ω und X_{Cs_WB}=12.16Ω.

FIG. 8 shows a controllable capacitor circuit 118′ according to the exemplary embodiment shown in FIG. 6. The change of the impedance level shown in FIG. 7 can be achieved in a simple manner using the illustrated controllable capacitor circuit 118′. The controllable capacitor circuit 118′ comprises switches S, which in the base status shown cause a direct connection in each line at the output 114 of the wallbox circuit 110. This base status corresponds to the impedance level shown by the curve 146 in FIG. 7. If necessary, i.e. if the coupling is not sufficient, the switches are switched into the position shown by dashed lines, so that the series capacitors C₁ and C₂ are switched on. This status then corresponds to the impedance level shown by the curve 147 in FIG. 7. If necessary, the controllable capacitor circuit can be expanded with multiple capacitors and corresponding statuses. As mentioned above, according to the invention, the controllable capacitor circuit 118′ can alternatively also be attached at the input 122 of the ground circuit 120.

It should be noted that the term “comprising” does not exclude other elements or steps and that the use of the article “a/an” does not exclude a plurality. Elements that are described in connection with various embodiments can also be combined. It should also be noted that reference signs in the claims should not be interpreted as limiting the scope of the claims.

The following is a summary list of reference numerals and the corresponding structure used in the above description of the invention:
10,110 wallbox circuit
12, 112 inverter
14, 114 output
16, 116 filter circuit
118, 118′ controllable capacitor circuit
20,120 ground circuit
22, 122 input
24, 124 charging coil
26, 126 series capacitor circuit
30, 130 cable
L1 inductance
L2 inductance
41-44 diagram
411-413 curve
421-423 curve
431-433 curve
441-443 operating points
444 arrow
145 diagram
146, 147 curve
S switch
C1, C2 series capacitor

1. A device for inductively charging an electrical energy storage apparatus, the device comprising:
a wallbox circuit having an inverter and an output;
a ground circuit having an input and a charging coil;
a cable providing an electrical connection between said output of said wallbox circuit and said input of said ground circuit; and
a controllable capacitor circuit configured to set a series capacitance at said output of said wallbox circuit or at said input of said ground circuit, in order to achieve impedance matching to a receiver circuit connected to the electrical energy storage apparatus.

2. The device according to claim 1, wherein said controllable capacitor circuit has at least one series capacitor, said controllable capacitor circuit is configured to set the series capacitance at said output of said wallbox circuit or at said input of said ground circuit by switching on or off said at least one series capacitor.

3. The device according to claim 2, wherein said output and/or said input has two conductors, wherein a switching on or off of said at least one series capacitor takes place in one of said two conductors or in both of said conductors.

4. The device according to claim 1, wherein said controllable capacitor circuit is configured to switch between a plurality of states, wherein in each of said states, a respective series capacitance of said series capacitances is set at said output of said wallbox circuit or at said input of said ground circuit.

5. The device according to claim 4, wherein said plurality of states contains a state in which no series capacitor is switched on at said output of said wallbox circuit or at said input of said ground circuit.

6. The device according to claim 4, wherein said plurality of states includes a first state in which at least one first series capacitor of said controllable capacitor circuit is switched on at said output of said wallbox circuit or at said input of said ground circuit.

7. The device according to claim 6, wherein the plurality of states contains a second state in which at least one second series capacitor of said controllable capacitor circuit is switched on at said output of said wallbox circuit or at said input of said ground circuit.

8. The device according to claim 7, wherein said at least one first series capacitor and said at least one second series capacitor have different capacitances.

9. The device according to claim 1, wherein the device is configured for charging a battery of an electric vehicle.

10. A charging method, which comprises the steps of:
providing the device according to claim 1; and
charging the electrical energy storage apparatus using the device.

11. The charging method according to claim 10, wherein the electrical energy storage apparatus is a battery of an electric vehicle.

12. A method for charging an electrical energy storage apparatus, which comprises the steps of:
providing a wallbox circuit having an inverter and an output;
providing a ground circuit having an input and a charging coil;
providing a cable providing an electrical connection between the output of the wallbox circuit and the input of the ground circuit; and
providing a controllable capacitor circuit configured to set a series capacitance at the output of the wallbox circuit or at the input of the ground circuit in order to achieve impedance matching to a receiver circuit connected to the electrical energy storage apparatus.
